(19) United States
(12) Patent Application Publication
(10) Pub. No.: US 2019/0202230 A1
(43) Pub. Date: Jul. 4, 2019

(54) ART SUPPLIES ORGANIZATION ASSEMBLY

(71) Applicant: Studio Designs Inc., Commerce, CA (US)

(72) Inventor: Scott Maynes, Commerce, CA (US)

(21) Appl. No.: 16/237,970

(22) Filed: Jan. 2, 2019

Related U.S. Application Data
(60) Provisional application No. 62/612,807, filed on Jan. 2, 2018.

(51) Int. Cl. B43M 99/00; A45C 11/34; F16M 13/02

(52) U.S. Cl. CPC B43M 99/008; F16M 13/02; A45C 11/34

(57) ABSTRACT

An art supplies organization assembly organizes artist supplies, measuring instruments, and communication devices while detachably attached to an edge of a working surface. The assembly provides an elongated metal tray defined by at least one circular depression for receiving a cylindrical container, and at least one rectangular depression for receiving a foam organizer. The metal tray also comprises a longitudinal groove that couples to an edge of a working surface. The foam organizer has a top planar surface and a bottom planar surface. The top planar surface forms square-shaped or circular-shaped cavities for receiving an artist instrument. The top planar surface also forms a rectangular cavity to receive a communication device. The foam organizer fits into the rectangular cavity in a friction fit relationship for easy detachability and independent use from metal tray. The cylindrical container fits into cylindrical cavity for easy detachability and independent use from the metal tray.

### FIELD OF THE INVENTION

The present invention relates generally to an art supplies organization assembly. More so, an organization assembly provides an elongated metal tray defined by at least one circular depression for receiving a cylindrical container, at least one rectangular depression for receiving a foam organizer, and a longitudinal groove for detachably coupling to an edge of a working surface; whereby the foam organizer is defined by a top planar surface and a bottom planar surface; whereby the top planar surface forms at least one square-shaped or circular-shaped cavity that is sized and dimensioned to receive an artist instrument, and at least one rectangular cavity that is sized and dimensioned to receive a communication device, a measuring device, or a processing device; whereby the cylindrical container is detachably insertable in the circular depression forming in the metal tray for retaining art supplies; whereby artist supplies and drawing instruments, such as drawing markers or paint tubes, are maintained in a preselected arrangement in the foam organizer and cylindrical container so that the artist is ready to work, without the need for setting or arranging the artist supplies and drawing instruments in a particular order.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A wide variety of equipment and supplies that can include paint brushes, paints, chalks, charcoal, pencils, water, and the like are common in an artist's toolkit. As a result, organization of these items and more is often lacking, making it difficult for the artist to perform tasks as mundane as finding the right brush when needed, finding a convenient stand to hold brushes without dropping paint all over the place, or even setting or arranging supplies and drawing instruments in a convenient order specific to the artist. Furthermore, when multiple artists are sharing the same brushes, paints, and other supplies, having a consistent organization of equipment is placement is paramount in order to avoid problems such as misplacement of brushes or accidental spillage. Therefore, an improved apparatus for holding, storing, and overall customization of the organization of an artist's supply is needed.

### SUMMARY

Illustrative embodiments of the disclosure are generally directed to an art supplies organization assembly that provides an elongated metal tray defined by a variety of features that promote for art supply organization. The organization assembly provides an elongated metal tray that is defined by at least one circular depression that can be used to receive a cylindrical container, at least one rectangular depression that can receive a foam organizer, and a longitudinal groove that enables detachable coupling to an edge of a working surface.

In one embodiment, the foam organizer is defined as having a top planar surface and a bottom planar surface; whereby the top planar surface so forms at least one square-shaped or circular-shaped cavity that is sized and dimensioned to receive an artist instrument. Furthermore, there is at least one rectangular cavity that is also sized and dimensioned so as to receive and hold a device that can include but is not limited to purposes of communication, measuring, or processing.

The organization assembly also has a cylindrical depression capable of receiving a cylindrical container. The cylindrical container is detachable and insertable in the circular depression forming in the metal tray for the purpose of retaining art supplies; maintaining in a preselected arrangement the artist supplies and drawing instruments, such as drawing markers or paint tubes, in the foam organizer and cylindrical container so that the artist is ready to work, without requiring or needing to set or arrange said artist supplies and drawing instruments in their desired particular order.

The organization assembly provides configuration that can organize such supplies as paint brushes, paints, pens, pencils, markers, and the like as well as facilitate easy access convenience for the artist when utilizing the organization assembly.

It is an object of the present invention to provide an improved device for organizing and holding artist supplies.

Other objects and advantages of the present invention will become apparent from the following description of the preferred embodiment of said invention.

### BRIEF DESCRIPTION OF THE DRAWINGS

The invention will now be described, by way of example, with reference to the accompanying drawings, in which:

FIG. 1 illustrates a perspective view of an exemplary art supplies organization assembly having a metal tray with one foam organizer, in accordance with an embodiment of the present invention;

FIG. 2 illustrates a perspective view of the art supplies organization assembly shown in FIG. 1 having a metal tray with two foam organizers, in accordance with an embodiment of the present invention;

FIG. 3 illustrates a perspective view of the art supplies organization assembly shown in FIG. 1 having a metal tray with three foam organizers, in accordance with an embodiment of the present invention;

FIG. 4 illustrates a close up view of the metal tray coupling to a working surface through a longitudinal groove, in accordance with an embodiment of the present invention;

FIG. 5 illustrates a perspective view of an art supplies organization assembly with one foam organizer, holding a marking instrument and a communication device, in accordance with an embodiment of the present invention;

FIG. 6 illustrates a perspective view of the art supplies organization assembly with two foam organizers, in accordance with an embodiment of the present invention;

FIG. 7 illustrates a perspective view of the art supplies organization assembly with three foam organizers, in accordance with an embodiment of the present invention;

FIG. 8 illustrates a perspective view of an exemplary foam organizer defined by a first embodiment of square cavities and a rectangular cavity, in accordance with an embodiment of the present invention;

FIG. 9 illustrates a perspective view of an exemplary foam organizer defined by a second embodiment of square cavities and a rectangular cavity, in accordance with an embodiment of the present invention;

FIG. 10 illustrates a perspective view of an exemplary foam organizer defined by a third embodiment of square cavities and a rectangular cavity, in accordance with an embodiment of the present invention; and

FIG. 11 illustrates a perspective view of a foam organizer having square cavities for retaining marking instruments, paint, and a rectangular cavity for retaining a cell phone, in accordance with an embodiment of the present invention.

Like reference numerals refer to like parts throughout the various views of the drawings.

### DETAILED DESCRIPTION OF THE INVENTION

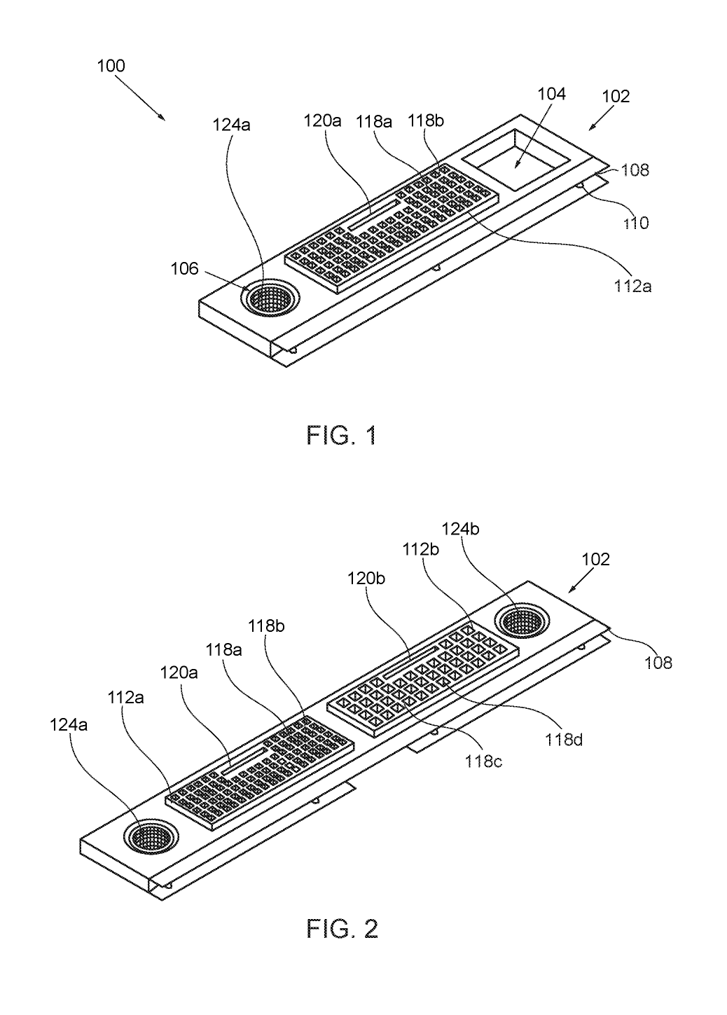

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment of the present invention presented in FIGS. 1-11, an art supplies organization assembly 100 helps organize artist supplies, measuring instruments, communication devices 204, and processing devices while detachably attached to an edge of a working surface 200. The organization assembly 100 provides an elongated metal tray 102 that is defined by at least one circular depression 106 for receiving a cylindrical container 122a-b, and at least one rectangular depression 104 for receiving a foam organizer 112a-c. The metal tray 102 also comprises a longitudinal groove 108 that is configured to detachably couple to the edge of the working surface 200 for selective placement thereof.

In some embodiments, the foam organizer 112a-c that fits into the rectangular depression 104 forming in the metal tray 102 is defined by a top planar surface 114 and a bottom planar surface 116. The top planar surface 114 of the foam organizer 112a-c forms at least one square-shaped or circular-shaped cavity 118a-f that is sized and dimensioned to receive an artist instrument 202a-d, such as paint brushes, marking instruments, and also various measurement instruments known in the art. The top planar surface 114 also forms at least one rectangular-shaped cavity 120a-c that is sized and dimensioned to receive a communication device 204, a measuring instrument, or a processing device.

The foam organizer 112a-c is unique in that it fits into the rectangular-shaped cavity 120a-c in a friction fit relationship for easy detachability and independent use from the metal tray 102. The cylindrical container 122a-b fits into the cylindrical cavity for easy detachability and independent use from the metal tray 102. Also, the foam composition allows the foam organizer 112a-c to be custom cut to fit into various sizes and dimensions of depressions in the metal tray 102.

In some embodiments, at least one cylindrical container is 122a-b detachably insertable in the circular depression 106 forming in the metal tray 102. The cylindrical container 122a-b operates both in conjunction with, and independently of the metal tray 102 to retain artist supplies and drawing instruments, such as drawing markers or paint tubes. Through use of both the foam organizer 112a-c and the cylindrical container is 122a-b, the artist supplies are maintained in a preselected arrangement in the foam organizer and cylindrical container, so that the artist is ready to work, without the need for setting or arranging the artist supplies and drawing instruments in a particular order.

One aspect of the art supplies organization assembly 100, comprises: a metal tray 102 defined by at least one rectangular depression 104, at least one circular depression 106, and a longitudinal groove 108 sized and dimensioned to couple to an edge of a working surface 200; at least one foam organizer 112a-c defined by a top planar surface 114 and a bottom planar surface 116, the top planar surface 114 forming at least one square-shaped or circular-shaped cavity 118a-f sized and dimensioned to receive an artist instrument 202a-d and a measuring device, the top planar surface 114 further forming at least one rectangular-shaped cavity 120a-c sized and dimensioned to receive a communication device 204, a measuring device, and a processing device, the foam organizer 112a-c detachably insertable in the rectangular depression 104 forming in the metal tray 102 through a friction fit relationship, whereby the foam organizer 112a-c operates both in conjunction with, and independently of the metal tray 102; and at least one cylindrical container 122a-b detachably insertable in the circular depression 106 forming in the metal tray 102, whereby the cylindrical container 122a-b operates both in conjunction with, and independently of the metal tray 102.

In another aspect, the longitudinal groove 108 of the metal tray 102 forms at least one fastening hole 110.

In another aspect, the assembly 100 further comprises a fastener 124 for fastening the metal tray 102 to the working surface 200 through the fastening hole 110.

In another aspect, the foam organizer 112a-c is fabricated from at least one of the following: polystyrene, polyurethane foam (foam rubber), quantum foam, XPS foam, phenolic, and lightweight cellular engineering materials.

In another aspect, the metal tray 102 has dimensions of a width between 23.5″ to 41.5″, a depth of 6.5″, and a height of 4″.

In another aspect, the cylindrical container 122a-b comprises a wire mesh cup.

In another aspect, the square-shaped and circular-shaped cavities have dimensions of 10 millimeters, 15 millimeters, and 25 millimeters.

One objective of the present invention is to provide a convenient organizer for art supplies that detachably couples to a working surface 200.

Another objective is to provide a foam organizer 112a-c that retains an artist instrument 202a-d, marking instruments, measurement devices, and communication devices 204, both while joined with the metal tray 102 and independently of the metal tray 102.

Another objective is to provide a cylindrical container 122a-b that retains an artist instrument 202a-d, marking instruments, measurement devices, and communication devices 204, both while joined with the metal tray 102 and independently of the metal tray 102.

Another objective is to provide an inexpensive to manufacture art supplies organization assembly 100.

Those skilled in the art will recognize that an artist is often required to prepare drawings under time pressure and in less-than-ideal circumstances, i e., cramped working space. These renderings are prepared using paint, brushes, colored drawing markers, and measurement tools, which are available in a large number of shades and tones of color. The artist may also need to communicate with clients while working on the rendering. Thus, it is not unusual for an artist to carry well over one hundred brushes, pencils, and drawing markers differing in color and shade.

Often, the artist carries these supplies jumbled in a bag. When reaching the work site, such an artist needs time for set-up, i.e., removing the supplies from the bag and arranging them in a particular order, usually with shades of the same color arranged next to each other. During the work period, brushes, paints, and markers invariably become rearranged and even misplaced. In addition, the art supplies are generally not easy to organize on a working surface 200, such as an artist's table. The present disclosure helps resolve these problems.

FIG. 1 references the art supplies organization assembly 100, showing various embodiments thereof. The organization assembly 100 comprises a generally elongated metal tray 102. The metal tray 102 is sized and dimensioned in a generally flat configuration that is defined by at least one rectangular depression 104, at least one circular depression 106, and a longitudinal groove 108 on one side. Suitable materials for the metal tray 102 may include, without limitation, a powder-coated steel frame, aluminum, and metal alloys.

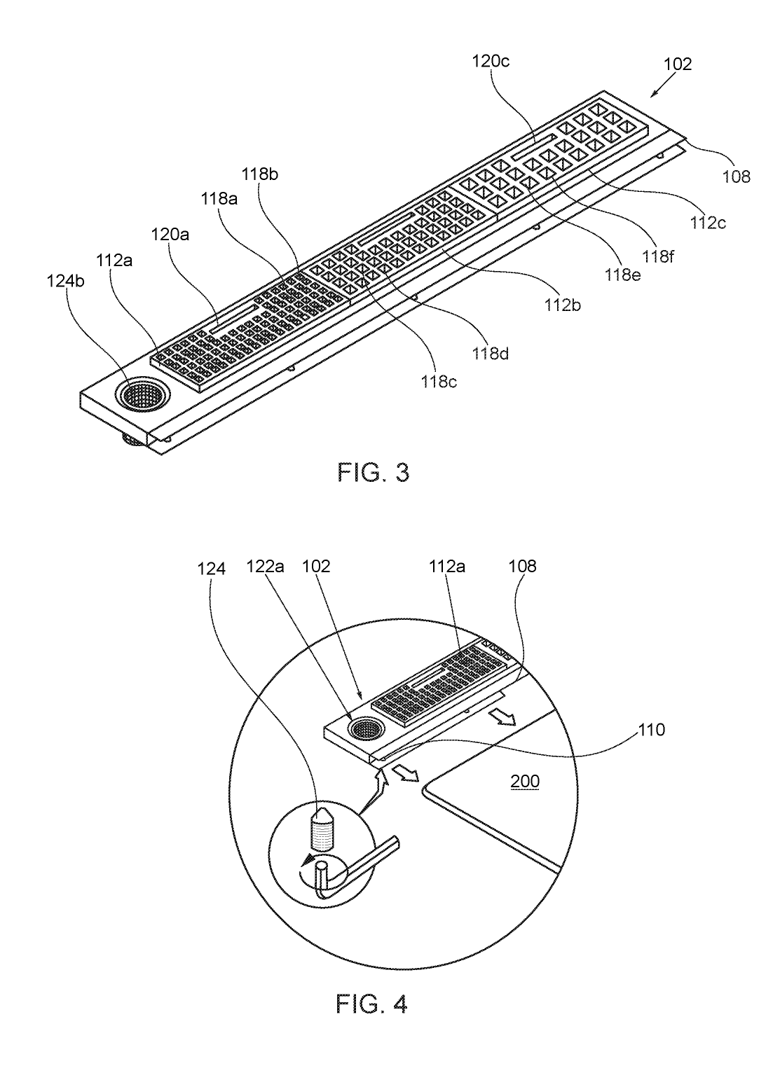

The depressions in the metal tray 102 are sized and dimensioned to receive two unique organizing members: at least one foam organizer 112a-c, and at least one cylindrical container 122a-b. FIG. 2 illustrates a metal tray 102 formed to receive two foam organizer 112a-cs. FIG. 3 illustrates a metal tray 102 formed to receive three foam organizers 112a-c. Though in other embodiments, the metal tray 102 may be configured to receive any number or size of foam organizers 112a-c.

The metal tray 102 also detachably couples to an edge of the working surface 200, which may include an artist's table or a drafting board. As FIG. 4 shows, the longitudinal groove 108 of the metal tray 102 is sized and dimensioned to align with, and couple along the edge of the working surface 200, such that the metal tray 102 can be easily repositioned.

The groove 108 forms along one edge of the metal tray 102, so as to align with the edge of the working surface 200. The width of the groove 108 may be a predetermined distance to adapt to various types of working surface 200 edges, or may be adjustable in other embodiments. In some embodiments, the groove 108 fits most studio designs tables and may fit other ⅝″ to ¾″ thick table tops.

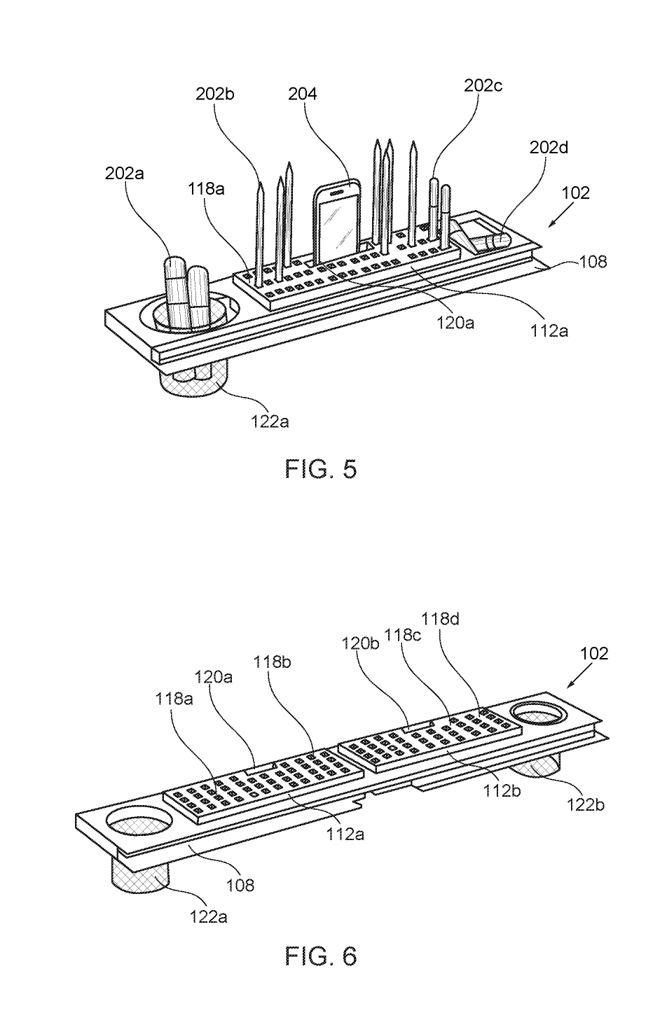

In one non-limiting embodiment, the longitudinal groove 108 forms at least one fastening hole 110. FIG. 5 shows four fastening holes forming in a spaced-apart disposition across the longitudinal groove 108. A fastener 124, such as a bolt or screw, may pass through the fastening hole 110 for fastening the metal tray 102 to the working surface 200 through the fastening hole 110. The fastener 124 presses against the working surface 200 to frictionally retain the metal tray 102 parallel and generally coplanar with the working surface 200. In this manner, a user may access any of the art supplies at a desired location on the working surface 200.

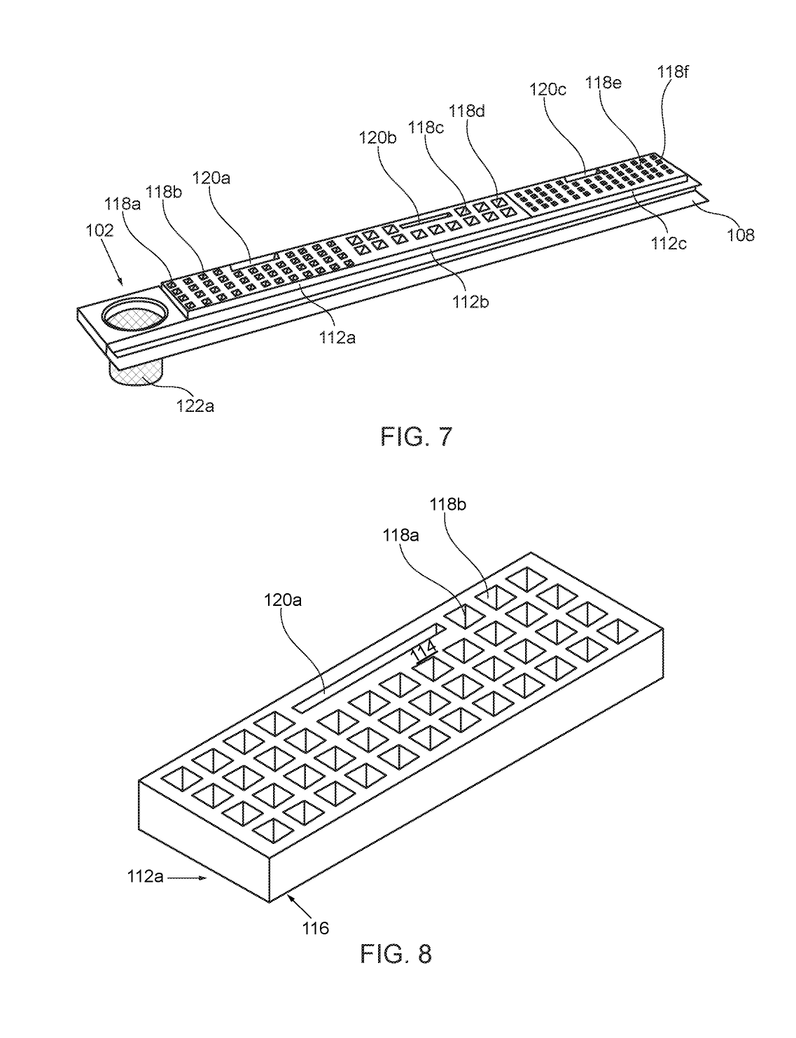

In one non-limiting embodiment, the metal tray 102 has dimensions of a width between 23.5″ to 41.5″, a depth of 6.5″, and a height of 4″. For example, FIG. 5 shows a metal tray 102 with dimensions of 23.5″ width×6.5″ depth, and 4″ height. FIG. 6 shows a metal tray 102 with dimensions of 35.5″ width×6.5″ depth, and 4″ height. FIG. 7 shows a metal tray 102 with dimensions of 41.5″ width×6.5″ depth, and 4″ height.

Turning now to FIG. 8, the assembly 100 further comprises at least one foam organizer 112a-c that detachably attaches to the metal tray 102, and functions to organize the art supplies and communication device 204, both in conjunction with, and independently of the metal tray 102. The foam organizer 112a-c is defined by a top planar surface 114 and a bottom planar surface 116, that form a generally rectangular shape.

The top planar surface 114 of the foam organizer 112a-c forms at least one square-shaped or circular-shaped cavity 118a-f that is sized and dimensioned to receive an artist instrument 202a-d, and a measuring device. The foam material is sufficiently resilient to expand and contract around the artist instrument 202a-d and the measuring device.

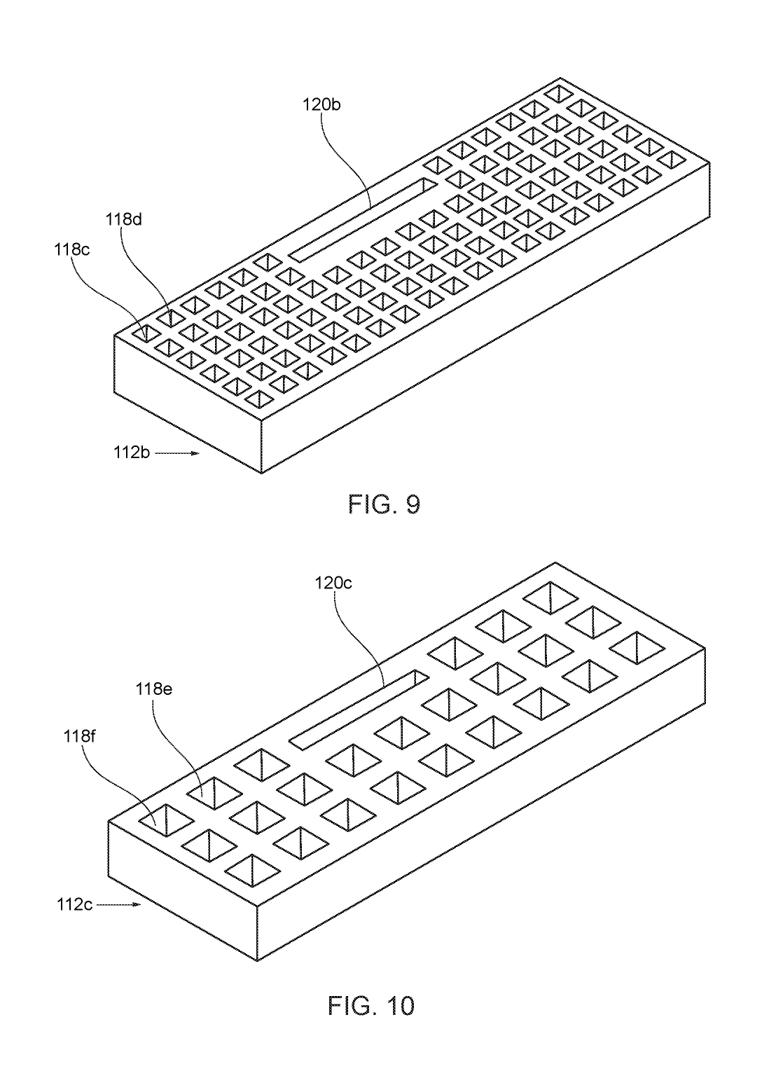

For example, FIG. 8 illustrates a perspective view of an exemplary foam organizer 112a-c defined by a first embodiment of square cavities and a rectangular-shaped cavity 120a-c. FIG. 9 illustrates a perspective view of an exemplary foam organizer 112a-c defined by a second embodiment of square cavities and a rectangular-shaped cavity 120a-c. FIG. 10 illustrates a perspective view of an exemplary foam organizer 112a-c defined by a third embodiment of square cavities and a rectangular-shaped cavity 120a-c. The first embodiment of square cavities 118a, 118b are medium sized, about 15 millimeters. The second embodiment of square cavities 118c, 118d are small sized, about 10 millimeters. The third embodiment of square cavities 118e, 118f are large sized, about 25 millimeters.

As discussed above, the top planar surface 114 also forms at least one rectangular-shaped cavity 120a-c that is sized and dimensioned to receive a communication device 204, a measuring device, and a processing device. The communication device 204 may include, without limitation, a cell phone, a processor, a tablet, and a ruler. Though any device or instrument used by an artist or drafter may be stored in the foam organizer 112a-c.

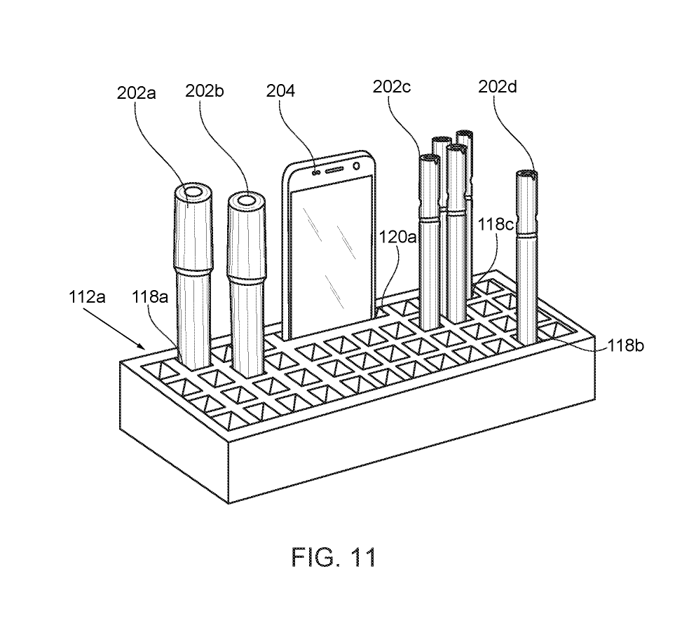

As FIG. 11 shows, the foam organizer 112a-c is detachably insertable in the rectangular depression 104 that forms in the metal tray 102 through a friction fit relationship. The foam organizer 112a-c may fit into various rectangular depression 104s, from the same metal tray 102, or in an interchangeable arrangement with other metal trays. The foam composition of the foam organizer 112a-c also allows it to be cut to custom-fit various types of rectangular depression 104. In this manner, the foam organizer 112a-c operates both in conjunction with, and independently of the metal tray 102.

In some embodiments, the foam organizer 112a-c is fabricated from at least one of the following: polystyrene, polyurethane foam (foam rubber), quantum foam, XPS foam, phenolic, and lightweight cellular engineering materials. The foam may be any variations of colors, patterns, and shapes known in the art and capable of fitting in the depressions of the metal tray 102. This unique utilization of foam material to fabricate a multi-cavity organizer allows for resizing to fit into variously sized and dimensioned rectangular depression 104 in the metal tray 102. Also, there are a greater variety of artist instrument 202a-d and instruments that can be fit into their respective cavities in the foam organizer 112a-c.

As discussed above, the metal tray 102 forms cavities that retain both the foam organizer 112a-c, and a cylindrical container 122a-b. In some embodiments, at least one cylindrical container 122a-b is detachably insertable in the circular depression 106 that forms in the metal tray 102. The cylindrical container 122a-b has an open end that receives artist supplies, and a closed end and sidewalls that retain the artist supplies within. By detachably fitting into the circular depression 106 in the metal tray 102, the cylindrical container 122a-b operates both in conjunction with, and independently of the metal tray 102. In one non-limiting embodiment, the cylindrical container 122a-b comprises a wire mesh cup. Though other cylindrical-shaped containment means known in the art may be used.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. An art supplies organization assembly, comprising:
an elongated metal tray defined by at least one rectangular depression, at least one circular depression, and a longitudinal groove sized and dimensioned to couple to an edge of a working surface;
at least one foam organizer defined by a top planar surface and a bottom planar surface, the top planar surface forming at least one square-shaped or circular-shaped cavity sized and dimensioned to receive an artist instrument and a measuring device, the top planar surface further forming at least one rectangular-shaped cavity sized and dimensioned to receive a communication device, a measuring device, and a processing device,
the foam organizer detachably insertable in the rectangular depression forming in the metal tray through a friction fit relationship, whereby the foam organizer operates both in conjunction with, and independently of the metal tray; and
at least one cylindrical container defined by an open end and a closed end, the cylindrical container detachably insertable in the circular depression forming in the metal tray, whereby the cylindrical container operates both in conjunction with, and independently of the metal tray.

2. The assembly of claim 1, wherein the longitudinal groove of the metal tray forms at least one fastening hole.

3. The assembly of claim 2, further comprising a fastener for fastening the metal tray to the working surface through the fastening hole.

4. The assembly of claim 1, wherein the metal tray has dimensions of a width between 23.5″ to 41.5″, a depth of 6.5″, and a height of 4″.

5. The assembly of claim 1, wherein the foam organizer is fabricated from at least one of the following: polystyrene, polyurethane foam (foam rubber), quantum foam, XPS foam, phenolic, and lightweight cellular engineering materials.

6. The assembly of claim 1, wherein the cylindrical container comprises a wire mesh cup.

7. The assembly of claim 1, wherein the square-shaped and circular-shaped cavities have dimensions of 10 millimeters, 15 millimeters, and 25 millimeters.
